(19) United States
(12) Patent Application Publication
(10) Pub. No.: US 2013/0106835 A1
(43) Pub. Date: May 2, 2013

(54) Stereoscopic Display System and Driving Method Thereof

(71) Applicants: Chia-Chiang Lin, Shenzhen City (CN); Hung-Lung Hou, Shenzhen City (CN); Cheng-Ming He, Shenzhen City (CN)

(72) Inventors: Chia-Chiang Lin, Shenzhen City (CN); Hung-Lung Hou, Shenzhen City (CN); Cheng-Ming He, Shenzhen City (CN)

(73) Assignee: Shenzhen China Star Optoelectronics Technology Co., LTD., Shenzhen City, Guangdong (CN)

(21) Appl. No.: 13/381,368

(22) PCT Filed: Nov. 3, 2011
(86) PCT No.: PCT/CN2011/081735

§ 371 Date: Dec. 28, 2011

(30) Foreign Application Priority Data
Oct. 28, 2011 (CN) 201110335196.6

(51) Int. Cl. G06F 3/038; G09G 3/36; G06T 15/00

(52) U.S. Cl. 345/419

(57) ABSTRACT

Embodiments of the present invention disclose a stereoscopic display system and a driving method thereof The stereoscopic display system includes a display unit, shutter glasses, and a backlight unit. The display unit displays a left-eye image and a right-eye image in a time division manner. The shutter glasses include a left-eye lens and a right-eye lens. The shutter glasses and the display unit alternately open and close the left-eye lens and the right-eye lens in synchronization with each other. The backlight unit supplies planar light to the display unit. Within a time period of activation of the shutter glasses, the shutter glasses show a transmittance in a first time interval smaller than a transmittance in a second time interval. The backlight unit includes first light source sections and second light source sections. The first light source sections have display brightness that is less than display brightness of the second light source sections. The first light source sections are closed in the first time interval and opened in the second time interval. The stereoscopic display system and the driving method thereof according to the present invention allow the display brightness of the stereoscopic display system to be more uniform.

### BACKGROUND OF THE INVENTION

1. Field of the Invention

The present invention relates to the field of displaying techniques, and in particular to a stereoscopic display system that has more uniform brightness and a driving method thereof.

2. The Related Arts

The basic principle of stereoscopy is to supply left and right eyes of a person with two different images, so that a stereoscopic image can be perceived once the brain of the person synthesizes these two images.

Stereopsis can be done in two ways, one with bare eyes and one with stereoscope. Viewing with bare eyes is subjected to severe limitation in respect of the positions of eyes and this leads to tiredness of eyes in making viewing and may easily causes crosstalk of images. Thus, in various applications, stereoscopes are used to view stereoscopic images.

Shutter glasses are a stereoscope and can be used by viewing a backlight unit. Since the lenses of the shutter glasses show low transmittance when they are just turned on, the displayed brightness at upper and lower edges of the backlight unit is relatively low. Consequently, at the time when the lenses of the shutter glasses are just turned on, viewing at the locations of the backlight unit where the brightness is low, especially the upper and lower edges of the backlight unit, the displaying effect that is being viewed is apparently dark. Compared to viewing made at locations of the lenses where the transmittance is high as having a great brightness shown at the middle portion of the backlight unit, the display brightness of the overall display zone that is being viewed is not uniform and thus, the displaying quality and viewer's perception of the stereoscope display system get deteriorating.

### SUMMARY OF THE INVENTION

The technical issue to be addressed by the present invention is to provide a stereoscopic display system that shows uniform brightness and a driving method thereof, for the purposes of reducing dark area of the display zone and making displayed brightness more uniform across the whole display zone.

An embodiment of the present invention discloses a stereoscopic display device, which comprise a display unit, shutter glasses, and a backlight unit. The display unit displays a left-eye image and a right-eye image in a time division manner. The shutter glasses comprise a left-eye lens and a right-eye lens. The shutter glasses and the display unit alternately open and close the left-eye lens and the right-eye lens in synchronization with each other. The backlight unit supplies planar light to the display unit. Within a time period of activation of the shutter glasses, the shutter glasses show a transmittance in a first time interval smaller than a transmittance in a second time interval. The backlight unit comprises two first light source sections located at top and bottom of the backlight unit and a plurality of second light source sections. The first light source sections haves display brightness that is less than display brightness of the second light source sections. The first light source sections are closed in the first time interval and opened in the second time interval. The two first light source sections are activated at adjacent time points within the second time interval of the shutter glasses.

In a preferred embodiment of the present invention, the backlight unit is a scan type backlight unit and the shutter glasses are active shutter glasses.

In a preferred embodiment of the present invention, the second light source sections are located between the top and bottom of the backlight unit.

In a preferred embodiment of the present invention, when the left-eye lens is open, the right-eye lens is closed and when the right-eye lens is open, the left-eye lens is closed.

In a preferred embodiment of the present invention, the first light source sections have a height less than or equal to 200 mm.

In a preferred embodiment of the present invention, the display unit is a liquid crystal display panel.

An embodiment of the present invention discloses a stereoscopic display system, which comprises a display unit, shutter glasses, and a backlight unit. The display unit displays a left-eye image and a right-eye image in a time division manner. The shutter glasses comprise a left-eye lens and a right-eye lens. The shutter glasses and the display unit alternately open and close the left-eye lens and the right-eye lens in synchronization with each other. The backlight unit supplies planar light to the display unit. Within a time period of activation of the shutter glasses, the shutter glasses show a transmittance in a first time interval smaller than a transmittance in a second time interval. The backlight unit comprises first light source sections and second light source sections. The first light source sections have display brightness that is less than display brightness of the second light source sections. The first light source sections are closed in the first time interval and opened in the second time interval.

In a preferred embodiment of the present invention, the backlight unit is a scan type backlight unit and the shutter glasses are active shutter glasses.

In a preferred embodiment of the present invention, the first light source sections are located at top or bottom of the backlight unit.

In a preferred embodiment of the present invention, the first light source sections are located at top and bottom of the backlight unit and the second light source sections are located between the top and bottom of the backlight unit.

In a preferred embodiment of the present invention, when the left-eye lens is open, the right-eye lens is closed and when the right-eye lens is open, the left-eye lens is closed.

In a preferred embodiment of the present invention, the first light source sections have a height less than or equal to 200 mm.

In a preferred embodiment of the present invention, the display unit is a liquid crystal display pane.

In a preferred embodiment of the present invention, the backlight unit comprises two first light source sections and a plurality of second light source sections, and the two first light source sections are activated at adjacent time points within the second time interval of the shutter glasses.

An embodiment of the present invention provides a driving method of stereoscopic display system. The driving method of stereoscopic display system comprises: setting shutter glasses and a display unit to alternately open and close a left-eye lens and a right-eye lens of the shutter glasses in synchronization with each other; and setting, within a time period of activation of the shutter glasses, first light source sections of a backlight unit that supplies illumination to the display unit to deactivate in a first time interval and activate in a second time interval, in which the shutter glasses show a transmittance in the first time interval smaller than a transmittance in the second time interval, the backlight unit further comprising second light source sections, the first light source sections having display brightness that is less than display brightness of the second light source sections.

In a preferred embodiment of the present invention, the backlight unit is a scan type backlight unit and the shutter glasses are active shutter glasses.

In a preferred embodiment of the present invention, the first light source sections are located at top and bottom of the backlight unit and the second light source sections are located between the first light source sections.

In a preferred embodiment of the present invention, when the left-eye lens is open, the right-eye lens is closed and when the right-eye lens is open, the left-eye lens is closed.

In a preferred embodiment of the present invention, the first light source sections have a height less than or equal to 200 mm.

The efficacy of the present invention is that to be distinguished from the state of the art, the stereoscopic display system and the driving method thereof according to the present invention activate the areas of the backlight unit that have relatively low display brightness at the time when the transmittance of the shutter glasses gets high, so that the dark area of the display zone can be reduced to make the display brightness of the whole display zone relatively uniform and improve the displaying quality and viewer's perception of the stereoscopic display system.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic view showing a stereoscopic display system according to an embodiment of the present invention;

FIG. 2 is a schematic view illustrating distribution of light source sections of a backlight unit of the stereoscopic display system of FIG. 1; and

FIG. 3 is a schematic view showing a plot of transmittance of lenses of shutter glasses of the stereoscopic display system of FIG. 1 varying with time.

### DETAILED DESCRIPTION OF THE PREFERRED EMBODIMENTS

A clear and complete description of the technical solution provided by embodiments of the present will be given with reference to the attached drawings associated with the embodiments of the present invention. It is apparent that the embodiments that will be described are only a few of the embodiments available for the present invention, not all the available embodiment of the present invention. Based on the embodiments of the present invention, those having ordinary skills in the art may, without putting in any creative efforts, easily obtain other embodiments that are considered within the protection scope of the present invention.

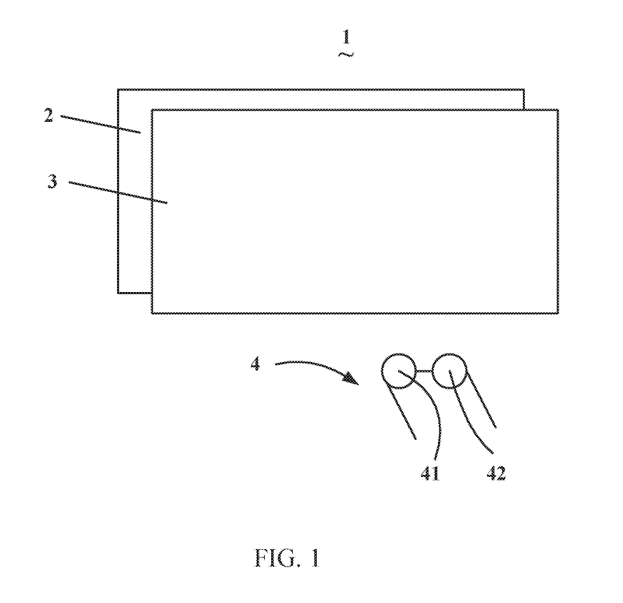

Referring to FIG. 1, FIG. 1 is a schematic view showing a stereoscopic display system according to an embodiment of the present invention. The stereoscopic display system 1 comprises a backlight unit 2, a display unit 3 and, shutter glasses 4.

The backlight unit 2 gives off planar light. The display unit 3 is arranged in front of the backlight unit 2 and uses the light emitting from the backlight unit 2 to display, in a time division manner, left-eye image and the right-eye image that are different. In the instant embodiment, the display unit 3 is a liquid crystal display panel. The shutter glasses 4 comprise a left-eye lens 41 and a right-eye lens 42. The shutter glasses 4 and the display unit 3 alternately open and close the left-eye lens 41 and the right-eye lens 42 in synchronization with each other so that a viewer use view, through the shutter glasses 4, the left-eye image and the right-eye image displayed on the display unit 3 to allow the brain to synthesize the two images to form an image of stereoscopic effect.

The backlight unit 2 is a scan type backlight unit 2, which comprises a plurality of light source sections. The plurality of light source sections is activated and deactivated in a time division manner. To facilitate the description, the instant embodiment will be described by taking an example that the backlight unit 2 comprises 9 light source sections BL1-BL9. Referring also to FIG. 2, the abscissa of FIG. 2 indicates the turn-on time of the lenses 41, 42 of the shutter glasses 4, and the ordinate indicates transmittance of the lenses 41, 42 of the shutter glasses 4. The light source section BL1 is at the upper edge of the backlight unit 2, and the light source section BL9 is at the lower edge of the backlight unit 2. The light source sections BL2-BL8 are located between the light source section BL1 and the light source section BL9 and are arranged sequentially from top to bottom. The light source sections BL1, BL9 that are located at the upper edge and the lower edge of the backlight unit 2 show display brightness that is lower than display brightness of the light source sections BL2-BL8. In the instant embodiment, the light source sections BL1, BL9 have a height less than or equal to or exceeding 200 mm.

The shutter glasses 4 are active shutter glasses 4. The left-eye lens 41 and the right-eye lens 42 are alternately opened and closed to prevent image crosstalk that is caused by incorrect images entering the viewer's eyes. In other words, when the display unit 3 displays a left-eye image, the left-eye lens 41 is opened and the right-eye lens 42 is closed; and when the display unit 3 displays a right-eye image, the left-eye lens 41 is closed and the right-eye lens 42 is opened.

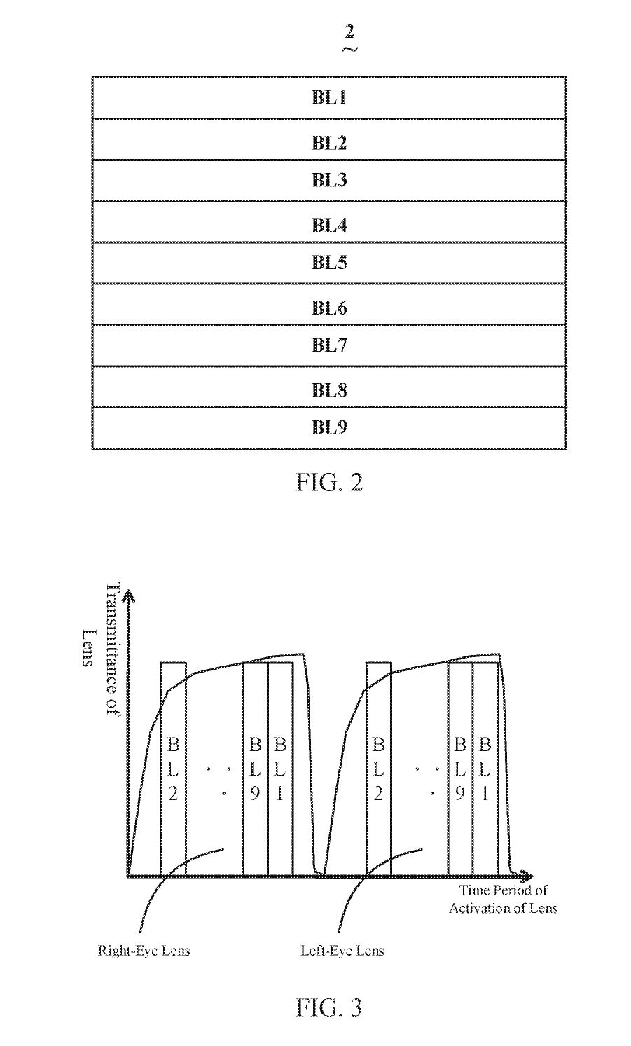

Referring to FIG. 3, taking the right-eye lens 42 as an example, when the display unit 3 displays a right-eye image, the left-eye lens 41 is closed and the right-eye lens 42 is opened. At the time of being just activated, the right-eye lens 42 shows a transmittance that is relatively low. The transmittance gets increased with the increase of activation time. When the right-eye lens 42 is closed, the transmittance lowers to the minimum level. It is apparent that in an activation cycle, the transmittance of the shutter glasses 4 within a first time interval is less than the transmittance within a subsequent second time interval.

Referring collectively to FIG. 2, in the activation time period of the right-eye lens 42 of the shutter glasses 4, the light source section BL1 is closed at the time when the right-eye lens 42 is just activated, and the light source sections BL2-BL8 are activated first, in a sequential manner. Although the transmittance of the right-eye lens 42 is relatively low at the time of being just activated, yet since the display brightness of the light source sections BL2-BL8 is relatively high, the display brightness of the frame that the viewer is viewing can still reach a relatively high level. The transmittance of the right-eye lens 42 gets approaching the maximum level within the activation time period thereof after a lapse of time following the activation, and the light source section BL9 is now activated and then, the light source section BL1 is subsequently activated by following the light source section BL9. Although the display brightness of the light source sections BL9 and BL1 n is relatively low, yet since in the process of activation of the light source sections BL9, BL1, the transmittance of the right-eye lens 42 is at a high level, the display brightness perceived by the viewer is close to the display brightness of BL2-BL8 at the time of being just activated. Thus, the stereoscopic display system 1 can show relatively uniform brightness within the complete activation time period of the right-eye lens 42 and the viewer may obtain an improved experience of viewing.

Similarly, the display brightness of the stereoscopic display system 1 can also be made relatively uniform within the time period of activation of the left-eye lens 41.

An embodiment of the present invention also provides a driving method of stereoscopic display system. The driving method of stereoscopic display system comprises:

Step S1, which sets shutter glasses and a display unit to alternately open and close a left-eye lens and a right-eye lens of the shutter glasses in synchronization with each other; and

Step S2, which sets, within a time period of activation of the shutter glasses, first light source sections of a backlight unit that supplies illumination to the display unit to deactivate in a first time interval and activate in a second time interval, in which the shutter glasses show a transmittance in the first time interval smaller than a transmittance in the second time interval, the backlight unit further comprising second light source sections, the first light source sections having display brightness that is less than display brightness of the second light source sections.

The driving method of stereoscopic display system according to the present invention can be further appreciated by simultaneously referring to the stereoscopic display system 1 described above. A detailed description of the driving operation can be referred to the description given above with reference to the stereoscopic display system 1 and repeated illustration will be omitted herein.

In the driving method of stereoscopic display system described above, the backlight unit is a scan type backlight unit and the shutter glasses are active shutter glasses. The first light source section is located at the top and bottom of the backlight unit, while the second light source sections is located between the first light source sections.

Similar to the above described stereoscopic display system, the driving method of stereoscopic display system drives the first light source section that has a relatively low display brightness to activate at the time when the transmittance of the shutter glasses gets high so that the overall display brightness of the stereoscopic display system is made relatively uniform and the viewer may gain an improved experience of viewing.

In summary, the stereoscopic display system and the driving method thereof according to the present invention activate the areas of the backlight unit that have relatively low display brightness only at the time when the transmittance of the shutter glasses gets high, so that the top edge dark area of the display zone can be reduced to make the display brightness of the whole display zone relatively uniform and improve the displaying quality and viewer's perception of the stereoscopic display system.

Embodiments of the present invention have been described, but not intending to impose any undue constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A stereoscopic display system, comprising a display unit, shutter glasses, and a backlight unit, the display unit displaying a left-eye image and a right-eye image in a time division manner, the shutter glasses comprising a left-eye lens and a right-eye lens, the shutter glasses and the display unit being operable to alternately open and close the left-eye lens and the right-eye lens in synchronization with each other, the backlight unit supplying planar light to the display unit, wherein within a time period of activation of the shutter glasses, the shutter glasses show a transmittance in a first time interval smaller than a transmittance in a second time interval, the backlight unit comprising two first light source sections located at top and bottom of the backlight unit and a plurality of second light source sections, the first light source sections having display brightness that is less than display brightness of the second light source sections, the first light source sections being closed in the first time interval and opened in the second time interval, the two first light source sections being activated at adjacent time points within the second time interval of the shutter glasses.

2. The stereoscopic display system as claimed in claim 1, wherein the backlight unit is a scan type backlight unit and the shutter glasses are active shutter glasses.

3. The stereoscopic display system as claimed in claim 1, wherein the second light source sections are located between the top and bottom of the backlight unit.

4. The stereoscopic display system as claimed in claim 1, wherein when the left-eye lens is open, the right-eye lens is closed and when the right-eye lens is open, the left-eye lens is closed.

5. The stereoscopic display system as claimed in claim 1, wherein the first light source sections have a height less than or equal to 200 mm.

6. The stereoscopic display system as claimed in claim 1, wherein the display unit is a liquid crystal display panel.

7. A stereoscopic display system, comprising a display unit, shutter glasses, and a backlight unit, the display unit displaying a left-eye image and a right-eye image in a time division manner, the shutter glasses comprising a left-eye lens and a right-eye lens, the shutter glasses and the display unit being operable to alternately open and close the left-eye lens and the right-eye lens in synchronization with each other, the backlight unit supplying planar light to the display unit, wherein within a time period of activation of the shutter glasses, the shutter glasses show a transmittance in a first time interval smaller than a transmittance in a second time interval, the backlight unit comprising first light source sections and second light source sections, the first light source sections having display brightness that is less than display brightness of the second light source sections, the first light source sections being closed in the first time interval and opened in the second time interval.

8. The stereoscopic display system as claimed in claim 7, wherein the backlight unit is a scan type backlight unit and the shutter glasses are active shutter glasses.

9. The stereoscopic display system as claimed in claim 7, wherein the first light source sections are located at top or bottom of the backlight unit.

10. The stereoscopic display system as claimed in claim 7, wherein the first light source sections are located at top and bottom of the backlight unit and the second light source sections are located between the top and bottom of the backlight unit.

11. The stereoscopic display system as claimed in claim 7, wherein when the left-eye lens is open, the right-eye lens is closed and when the right-eye lens is open, the left-eye lens is closed.

12. The stereoscopic display system as claimed in claim 7, wherein the first light source sections have a height less than or equal to 200 mm.

13. stereoscopic display system as claimed in claim 7, wherein the backlight unit comprises two first light source sections and a plurality of second light source sections, the two first light source sections being activated at adjacent time points within the second time interval of the shutter glasses.

14. The stereoscopic display system as claimed in claim 7, wherein the display unit is a liquid crystal display panel.

15. A driving method of a stereoscopic display system, comprising:
setting shutter glasses and a display unit to alternately open and close a left-eye lens and a right-eye lens of the shutter glasses in synchronization with each other; and
setting, within a time period of activation of the shutter glasses, first light source sections of a backlight unit that supplies illumination to the display unit to deactivate in a first time interval and activate in a second time interval, in which the shutter glasses show a transmittance in the first time interval smaller than a transmittance in the second time interval, the backlight unit further comprising second light source sections, the first light source sections having display brightness that is less than display brightness of the second light source sections.

16. The driving method of a stereoscopic display system as claimed in claim 15, wherein the backlight unit is a scan type backlight unit and the shutter glasses are active shutter glasses.

17. The driving method of a stereoscopic display system as claimed in claim 16, wherein the first light source sections are located at top and bottom of the backlight unit and the second light source sections are located between the first light source sections.

18. The driving method of a stereoscopic display system as claimed in claim 15, wherein when the left-eye lens is open, the right-eye lens is closed and when the right-eye lens is open, the left-eye lens is closed.

19. The driving method of a stereoscopic display system as claimed in claim 15, wherein the first light source sections have a height less than or equal to 200 mm.
